(19) United States
(12) Patent Application Publication
(10) Pub. No.: US 2009/0145213 A1
(43) Pub. Date: Jun. 11, 2009

(54) TEST SYSTEM THAT FORMS OPPOSITE BRAKING

(76) Inventor: Timucin Bayram, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 12/066,581

(22) PCT Filed: Dec. 30, 2005
(86) PCT No.: PCT/IB05/54428

§ 371 Date: Mar. 12, 2008

(30) Foreign Application Priority Data
Aug. 12, 2005 (TR) 2005/03245

(51) Int. Cl. G01M 13/02

(52) U.S. Cl. 73/115.04; 73/117.01

(57) ABSTRACT

This invention is related to a test system that performs power transfer member's life, fatigue and ageing tests such as 4×4 vehicles' transfer boxes that transfer movement to the front axis or gearboxes. The test system realized to achieve the object of this invention, in its basic state, comprises at least one chassis where the components of the system are positioned on, an electric motor providing the rotation movement in the system, at least two safety couplings protecting the torque meter, a loading mechanism which provides (on the system to be installed the required load value) a locking system providing an opposite breaking load, a clutch that holds the opposite braking load on the system, a shaft axle to transmit the movement on the test part to the test parts mirror-image connected to the units' other side, a computer that controls systems' functionality and keeps a record of any kind of information, a digital screen where required data are projected while the system is working, a torque meter to measure the load on the system and at least two oil conditioning system to condition the oil heated in the system. The system characterized by forming the opposite brake load on itself.

### TECHNICAL FIELD

This invention is related to the test systems that make the power transfer member's life, fatigue and ageing tests such as 4×4 vehicles' transfer boxes that transfer movement to the front axis or gearboxes.

### PRIOR ART

In the state of the art, tests of transfer boxes and gearboxes are made via a dynamometer. When the opposite breaking is made by a dynamometer, costs increase largely. Furthermore, using a dynamometer makes the design of those systems very complex.

There are various methods for making similar tests on the technique. The English Patent numbered GB381394 mentions ameliorations aimed at making the tests of brake system and tests of power transfer organs to the wheels by dynamometer.

In the English Patent numbered GB387371, a method directed towards providing the opposite braking, for the realization of the test, via a brake mechanism or dynamometer is described. In the English Patents numbered GB724846 and GB821052, usage of dynamometer aimed at testing the vehicles' movement transfer members is in question.

As mentioned above, usage of dynamometer in the tests of movement transfer member's life tests increases the costs largely. Moreover, test systems turn out to have a much more complex structure.

### BRIEF DESCRIPTION OF THE INVENTION

The object of this invention is to realize a test system that makes the power transfer member's life, fatigue and ageing tests such as 4×4 vehicles'—especially tractors'—transfer boxes that transfer movement to the front axis or gearboxes without using a dynamometer, but forming the opposite braking on itself.

Another object of this invention is to constitute a test system that is simpler and more cost effective than the systems using dynamometer.

The test system realized to achieve the object of this invention, in its basic state, comprising at least one chassis where the components of the system are positioned on, an electric motor providing the rotation movement in the system, at least two safety couplings protecting the torque meter, a loading mechanism which provides the system to be installed on the required load value, a locking system providing opposite breaking load to occur, a clutch that holds the opposite braking load on the system, a shaft axle to transmit the movement on the test part to the test parts mirror-image connected to units' other side, a computer that controls systems' working and keeps the record of any kind of information, a digital screen where required data are projected while the system is working, a torque meter to measure the load on the system and at least two oil conditioning system to condition the oil heated in the system, characterized by forming the opposite brake load on itself.

### DETAILED DESCRIPTION OF THE INVENTION

The test system to achieve the object of this invention is described in attached figures, where;

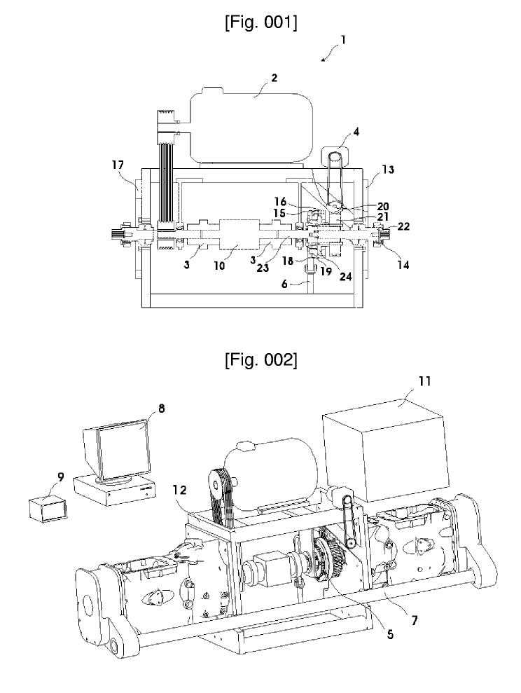

FIG. 1 is a side cross-section view of test system,

FIG. 2 is a perspective view of test system with the parts to be tested is set,

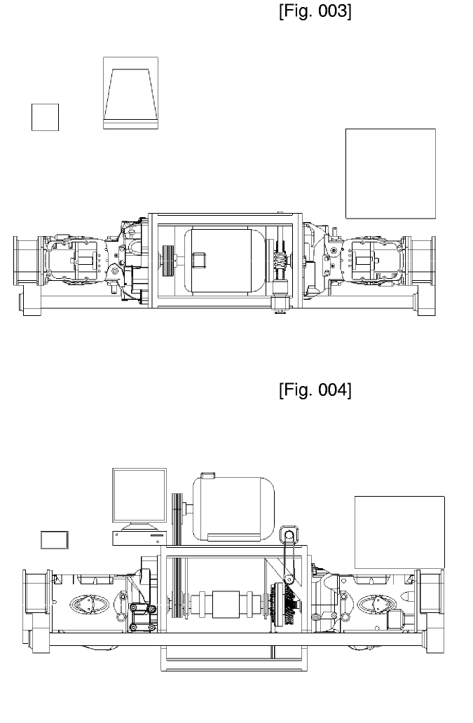

FIG. 3 is a top view of test system with the parts to be tested is set,

FIG. 4 is a side view of test system with the parts to be tested is set,

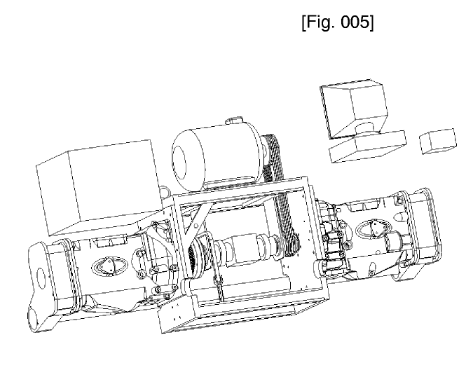

FIG. 5, is a view of test system from another angle with the parts to be tested is set.

The parts on the system are numbered one by one and their equivalents are given below:
1. Test system
2. Electric motor
3. Coupling
4. Loading mechanism
5. Clutch
6. Locking system
7. Shaft axle
8. Computer
9. Screen
10. Torque meter
11. Oil conditioning system
12. Chassis
13. Main carrier assembly
14. Outer connection flange
15. Inner connection flange
16. Connection flange
17. Symmetric part connection point
18. Locking gear
19. Connection bolt
20. Helical screw
21. Warm gear
22. Main movement shaft
23. Intermediate movement shaft
24. Coupling part

The test system realized to achieve the object of this invention, fundamentally, comprising at least one chassis (12) where the components of the system are positioned on, an electric motor (2) providing the rotation movement in the system, at least two safety couplings (3) protecting the torque meter (10), a loading mechanism (4) which provides the system to be installed on the required load value, a locking system (6) providing opposite breaking load to occur, a clutch (5) that holds the opposite braking load on the system, a shaft axle (7) to transmit the movement on the test part to the test parts mirror-image connected to units' other side, a computer (8) that controls systems' working and keeps the record of any kind of information, a digital screen (9) where required data are projected while the system is working, a torque meter (10) to measure the load on the system and at least two oil conditioning (11) system to condition the oil heated in the system, characterized by forming the opposite brake load on itself.

Chassis (12) is the carrier of whole test system (1) and forms the main framework of the system. Electric motor (2) that turns the units to be tested, loading an locking mechanisms (4 and 6) and system at the desired turnover is assembled to the main chassis (12). Chassis is not fixed; it can be fixed to desired place.

Electric motor (2) is added to the system (1) to ensure that the test system is turned at the desired turnover and load and time. Its working system is quite simple. It steps in with a button and steps out again with a button. Electric motor (2) is fed from main panel, can turn to right or left, designed to adjust its turning direction in the automatic set time. It starts the movement of the test system (1) by turning a hoop via V straps. System stops and waits during the turns to right and left and restarts the test according to the turning direction by warning with a lamp.

Coupling (3) is added to the system (1) to prevent the loads which will occur during the test to damage the system or to minimize the damage. It unloads the system (1) by being broken when there is more load in the system (1) than the set load value. Thanks to this, minimum damage happens on the system.

Loading mechanism (4) is added to the system (1) to ensure bringing the system to the set value. By the electric motors' incitement of reducer through chain and wheels, and with the screw mechanism's taking action by the reducer, it is provided that the system (1) is set to desired load set. Loading mechanism (4) is moved forward and backward with a button at the main electric panel. For safety, the load is placed by pushing continuously to the button, when the button is released, load value stays constant. After the load value of the system is set via the undo button, the screw mechanism is separated by pushing the button continuously. The torque meter (10) added to the loading mechanism ensures the truth of the load values that are set. The torque meter (10) allows following the test loads' value continuously.

Clutch (5) ensures that the system (1) is tested at the set value by being locked after the system is loaded to the desired load value. Clutch (5) is fizzled out before the installation of test system (1) and stays unconnected while the system is being installed. It is locked after the system is load and keeps locked during the testing period. Its locking is provided by connection elements.

The main part which enables the test system (1) to be set to the desired load value is named as locking system (6). When the system is brought to loading position, the locking system (6) is put into service to lock the test system (1) and system becomes locked against loading by the locking system (6) so that the system (1) is set to the desired load value.

Shaft axle (7) provides transfer of movement between the part to be tested and the symmetric part connected to the other side. Thanks to this, systems' loading on itself is possible.

Computer (8) supervises all the controls by software. It takes the data related to the test, records those data as desired or shows them on the digital screen. Software can also stop the test by the automatic pilot warning that it will receive when load changes in the system happen.

Digital screen (9) is an electronic part on which set load values can be shown continuously. An electronic card in the digital screen (9) provides the system to work at the set values by working together with software. The electronic card within the digital screen (9) is connected to torque meter (10).

Symmetric chassis which symmetric part is going to be connected to is constituted for the system to be load. Symmetric chassis is made as the symmetric of the unit to be tested and loading is made by using that symmetric chassis.

Oil conditioning system (11) is used to condition the oil that is heated in the unit which is being tested during the test. Two oil conditioning systems (11) are used to condition that oil in a specific temperature. One is used to condition the oil in the unit which is being tested, the other one is used to condition the oil in the unit which is on the other side.

Application of the Invent to Industry

The unit to be tested is connected to main carrier assembly (13) in the test system (1) by the design and production of outer connection flange (14) is made conveniently to the front connection form. The design and production of this outer connection flange (14) is made to provide the movement transfer between the part to be tested and the test system (1).

Symmetric of the unit to be tested is connected to the symmetric part connection point (17), which is just opposite side of the main carrier stem. The unit to be tested and its symmetric is supported from chassis (12) free from main carrier assembly (13) to prevent the load to be placed on main carrier assembly (13).

Locking system (6) is fixed to locking gear (18) so that test system (1) becomes ready to be loaded. During this, clutch (5) is released from inner connection flange and connection flange (15 and 16) and connection bolt (19). After the clutch (5) is released, load button at the electric panel is pushed for the loading mechanism (4) place the load and the loading mechanism (4) transfers the load to the helical screw (20) via a chain. In that way, test system (1) is loaded by the usage of loading mechanism (4) until it reaches to the load value to be tested. Loading mechanism (4) ensures the warm gears' (21) rotation by inciting the helical screw (20). The warm gear (21) transfers that movement coming from loading mechanism (4) to the clutch (5).

Clutch (5) transfers that movement to movement shaft (22). Movement axle transfers the movement coming from loading mechanism (4) to the part of the unit to be tested, that will receive the main movement, by giving the movement to the outer connection flange (14). Thus, the movement coming from loading system (4) reaches to the unit that will be tested. The unit to be tested transfers the movement to the symmetric of the unit to be tested which is connected to the other side of the test system via the shaft axle (7) by passing through the 4×4 transfer box by transferring the movement, coming from the test system, according to the convenient gear. The movement coming from loading mechanism (4) is transferred to the inner connection flange (15), connection flange (16) and main movement shaft (22) by passing from units' symmetric to be tested. This movement reaches to the torque meter (10) by passing over the couplings (3) from movement shaft (22). Torque meter (10) transfers the starting movement coming from loading mechanism (4) to the intermediate movement shaft (23) over couplings (3). Intermediate movement shaft (23) transfers the movement coming from loading mechanism (4) to the locking gear (18). Locking gear (18) is in a blocked and locked position by the locking system (6).

Thus, loading movement coming from loading mechanism (4) forms the test system by twisting the test system (1) until the desired test load value. Test system (1) and the unit to be tested is loaded by being twisted until the load value which is going to be set from loading mechanism (4). When the desired load value is reached loading mechanism (4) stops and loading is completed.

Fastness of the load in the test system (1) is provided by locking clutch part (24), connection flanges (15 and 16) and connection bolt (19). Test system (1) gets ready to start the test by the unleashing of the locking system (6). It is provided that the oil is conditioned in a specific temperature by putting the oil conditioning system (11) into service and by preventing the oil in the units' sprocket boxes to be tested in the test system (1) to be extremely heated. Units' selected gear position to be tested is locked to prevent out of gear situation under load to occur. Furthermore, 4×4 mechanism incitation crank is locked to prevent out of gear situation under load to occur. All mechanic, electrical, hydraulic connections are controlled and data are entered to the computer via computer. Test is started by entering beginning date and time, test description, specification number, test type, vehicle model, expected minimum life, gear position, torque lower limit values and torque higher limit values.

With the inventions' subject test system (1), a test system that makes the power transfer member's life, fatigue and ageing tests such as 4×4 vehicles'—especially tractors'—transfer boxes, which transfer movement to the front axis, or gearboxes without using a dynamometer, but forming the opposite braking on itself. A simpler and more cost effective system is realized by this test system (1).

Around this main concept, development of various applications of this invention's test system is possible, and the invention essentially according to claims, cannot be limited to the examples described herein.

1. A test system (1) that makes the power transfer member's life, fatigue and ageing tests such as 4×4 vehicles'—especially tractors'—transfer boxes, which transfer movement to the front axis, or gearboxes, comprising; at least one chassis (12) where the components of the system are positioned on, an electric motor (2) providing the rotation movement in the system, at least two safety couplings (3) protecting the torque meter (10), a loading mechanism (4) which provides the system to be installed on the required load value, a locking system (6) providing opposite breaking load to occur, a clutch (5) that holds the opposite braking load on the system, a shaft axle (7) to transmit the movement on the test part to the test parts mirror-image connected to units' other side, a computer (8) that controls systems' working and keeps the record of any kind of information, a digital screen (9) where required data are projected while the system is working, a torque meter (10) to measure the load on the system and at least two oil conditioning (11) system to condition the oil heated in the system, and characterized by constituting the opposite braking load on itself.

2. A test system (1) according to claim 1 characterized with an electric motor (2) that starts the movement of the test system (1) to provide rotation of the test system at the desired turnover and load and time by turning a hoop via V straps by turning right or left.

3. A test system (1) according to claim 1 characterized with a coupling (3), thanks to which minimum damage happens on the system, as it unloads the system (1) by being broken when there is more load in the system (1) than the set load value to prevent the loads, which will occur during the test, to damage the system or to minimize the damage.

4. A test system (1) according to any one of the preceding claims characterized with a loading mechanism wherein electric motor (2) incites the reducer through chain and wheels, with the screw mechanism's taking action by that reducer, by the systems' (1) being set to desired load set, with a loading mechanism that is moved forward and backward with a button at the main electric panel, wherein, for safety reasons, the load is placed by pushing continuously to the button, the screw mechanism is separated by pushing the undo button continuously, and thanks to this, the system is loaded.

5. A test system (1) according to any one of the preceding claims characterized with a clutch (5) that is fizzled out before the installation of test system (1) and stays unconnected while the system is being installed, providing the system to be kept locked during the testing period by connection elements.

6. A test system (1) according to any one of the preceding claims characterized with a locking system (6) to lock the test system (1) and system becomes locked against loading when the system is brought to loading position and gets out of service after being set to the desired load value.

7. A test system (1) according to any one of the preceding claims characterized with a shaft axle that transfers movement between the part to be tested and the symmetric part connected to the other side, thanks to this, systems' loading on itself becomes possible.

8. A test system (1) according to any one of the preceding claims characterized with a computer that supervises all the controls by software, takes the data related to the test, records those data as desired or shows them on the digital screen (9) as graphics, further stops the test by the automatic pilot warning that it will receive when load changes in the system happen with the software it includes.

9. A test system (1) according to any one of the preceding claims characterized with an oil conditioning system (11) that is used to condition the oil heated in the unit which is being tested during the test.
